(19) United States
(12) Patent Application Publication
(10) Pub. No.: US 2001/0011572 A1
(43) Pub. Date: Aug. 9, 2001

(54) Device for sealing stitching threads

(76) Inventors: Lutz Richter, Schkeuditz (DE); Juergen Roeder, Engelsdorf (DE)

Correspondence Address: DAVIDSON, DAVIDSON & KAPPEL, LLC, 14th Floor, 485 Seventh Avenue, New York, NY, 10018, US

(21) Appl. No.: 09/738,096

(22) Filed: Dec. 16, 2000

(30) Foreign Application Priority Data
Dec. 15, 1999 (DE) DE 199 60 445.2

(51) Int. Cl. B32B 7/08; B31F 1/00

(52) U.S. Cl. 156/93; 156/227

(57) ABSTRACT

In a method and a device for hot-sealing material to be stitched, in particular paper, cardboard or the like, a hot-sealable thread clamp is introduced into the material to be stitched. The device for hot-sealing these stitching threads has a sealing element which is provided with a contact surface which touches the material to be stitched during the sealing operation. During the sealing operation, the contact surface moves essentially at the same speed as the material to be stitched.

### FIELD OF THE INVENTION

The present invention relates to a device for sealing stitching threads on material to be sealed, the material to be sealed being fed to the device for sealing with inserted sealing threads.

BACKGROUND OF THE INVENTION

German Patent DE 44 01 153 C1, purports to disclose a thread-sealing machine which features a heating bar. The folded sheets have inserted sealing threads which are pressed against the folded sheet while running over the heating bar so that the melting-thread component of the sealing thread melts and firmly bonds to the folded sheet.

It is a disadvantage of such devices for sealing that the thread which is to be sealed on and which usually glides over the heating bar in two thread clamp legs, is subject to a relative motion during the entire contact time with the thread-sealing machine. Since the thread clamp legs are drawn over the heating bar together with the folded sheet, a doctoring or frictional load on the thread clamp legs ensues which, in the worst case, cuts off the thread clamp legs. In practice, therefore, the process is predominantly carried out using a small pressure force of the heating bar, which, however, limits the holding force of the thread clamp legs on the folded sheet. Moreover, a great part of the thermoplastic material is frequently released out of the thread because of the frictional action between the thread clamp leg and the heating bar. This, however, reduces the adhesive action of the thread on the folded sheet. Furthermore, melting residues left on the heating bar can solidify, dirty the folded sheet, and lead to production breakdowns.

Accordingly, it is an object of the present invention to propose a sealing element for sealing folded sheets which makes it possible to achieve an improved adhesion of the thread clamp legs on the folded product.

### SUMMARY OF THE INVENTION

In accordance with a first embodiment of the present invention, a device for sealing stitching threads on material to be sealed to a moving folded sheet is provided which includes a heatable sealing element having a surface which touches a material to be sealed to a moving folded sheet during the sealing operation at a contact surface. The heatable sealing element is designed in such a manner that, during the sealing operation, the contact surface moves essentially at the same speed as the folded sheet.

In accordance with a second embodiment of the present invention, a method for hot-sealing material to be stitched, in particular made of paper, cardboard or the like is provided. The method includes the steps of: introducing hot-sealable thread clamps into a material to be stitched in the region of a folding line; moving the material to be stitched along a path in the direction of a hot-sealing element; and bringing the material to be stitched and the hot-sealable thread clamps into contact with a heatable sealing element, the surface of the heatable sealing element which is in contact with the material to be stitched and with the thread clamps moving essentially at the same speed as the material to be stitched.

The concept according to the present invention of providing a sealing element having a contact surface which is in contact with the material to be sealed during the sealing process and which moves at approximately the same speed as the material to be sealed, involves a series of advantages. Thus, no unwanted relative motion occurs between the sealing element and the thread clamp legs, which prevents the thread clamp legs from wear and a possible tear-off in a particular advantageous manner. Moreover, the quality of the thread sealing can be markedly increased since the pressure with which the contact surface of the sealing element acts upon the material to be sealed can be increased whereby the resulting better transmission of heat and pressure to the thread clamp legs gives rise to a better bond of the thread clamp legs to the material to be sealed.

### BRIEF DESCRIPTION OF THE DRAWINGS

Further advantages and advantageous embodiments of the present invention are dealt with in the following Figures and their descriptions, in whose representation a true-to-scale reproduction has been dispensed with to the advantage of clarity.

FIG. 1 shows a schematic representation of a sealing roller according to the present invention in a sectional view.

FIG. 2 shows a schematic representation of a sealing belt according to the present invention in a sectional view.

FIG. 3 shows a schematic representation of a sealing slide according to the present invention in a sectional view.

FIG. 4 shows the schematic representation of a thread and sealing station according to the present invention.

### DETAILED DESCRIPTION OF THE REFERRED EMBODIMENT

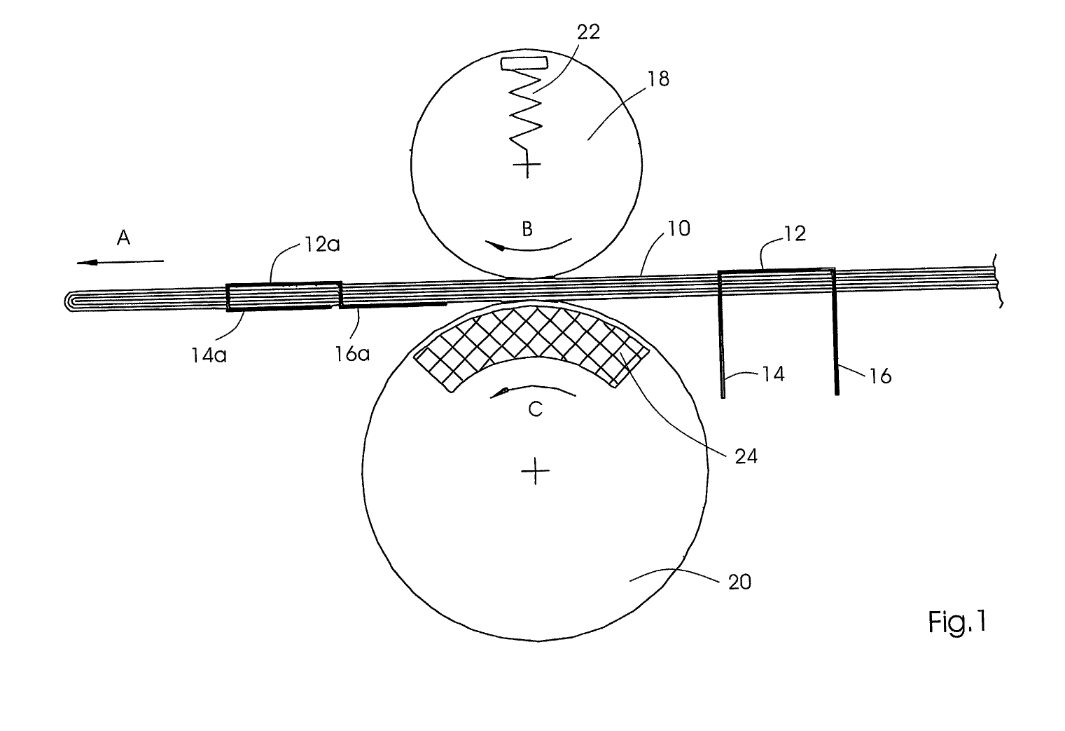

FIG. 1 shows a material to be sealed 10, for example, a folded sheet of paper, cardboard or the like moving in the direction of arrow A. The movement of folded sheet 10 is usually guaranteed by a conveying device (not shown). In a preceding thread station, specially twisted thread pieces, so-called “thread clamps” 12, which have a meltable component are inserted continually into the folded sheets to be sealed, usually in the folding line of the sheet. In the process, the thread clamp is inserted into the back of the folded sheet material in such a manner that a first thread clamp leg 14 and a second thread clamp leg 16 are located on the bottom side of the folded sheet. By further moving the folded sheet in direction A, thread clamp 12 gets into the gap between a counter-pressure roller 18 and a sealing roller 20. In this context, counter-pressure roller 18 rotates in direction of rotation B, and sealing roller 20 rotates in direction of rotation C. In this case, the counter-pressure roller, which can, at the same time, be used as conveyor roller, is supported with the assistance of a pressing device 22, for example, a spring in such a manner that thread clamp 12 running through the gap is pressed against sealing roller 20. The sealing roller usually has a heating element 24 extending at least along a subsection of the sealing roller. However, it is also possible for the heating element to be provided inside the sealing roller along the whole circumference. Moreover, provision can be made for a plurality of heating elements inside the sealing roller, the heating elements being separate from each other and capable of being controlled separately. While running through the gap between counter-pressure roller 18 and sealing roller 20, the pressure generated by the two rollers 18 and 20 acts upon thread clamp legs 14 and 16.

In addition, thread clamp legs 14 and 16 are subject to the action of heat generated by heating element 24. Because of this, thread clamp legs 14 and 16 are turned down in a direction opposite to conveying direction A and pressed against the paper. In the process, the thermoplastic thread component melts, firmly sealing the thread together with the folded product. During this operation, the surfaces of counter-pressure roller 18 and sealing roller 20 are moved essentially at the same conveying speed as the material to be sealed, i.e. folded sheet 10. In this manner, a gliding of the two thread clamp legs 14 and 16 at the sealing element is avoided so that a high contact pressure can be applied without tearing off the thread clamp legs. Subsequent to passing the gap between sealing roller 20 and counter-pressure roller 18, the thread clamp is firmly joined to the folded product with its legs 14a and 16a, as shown in 12a.

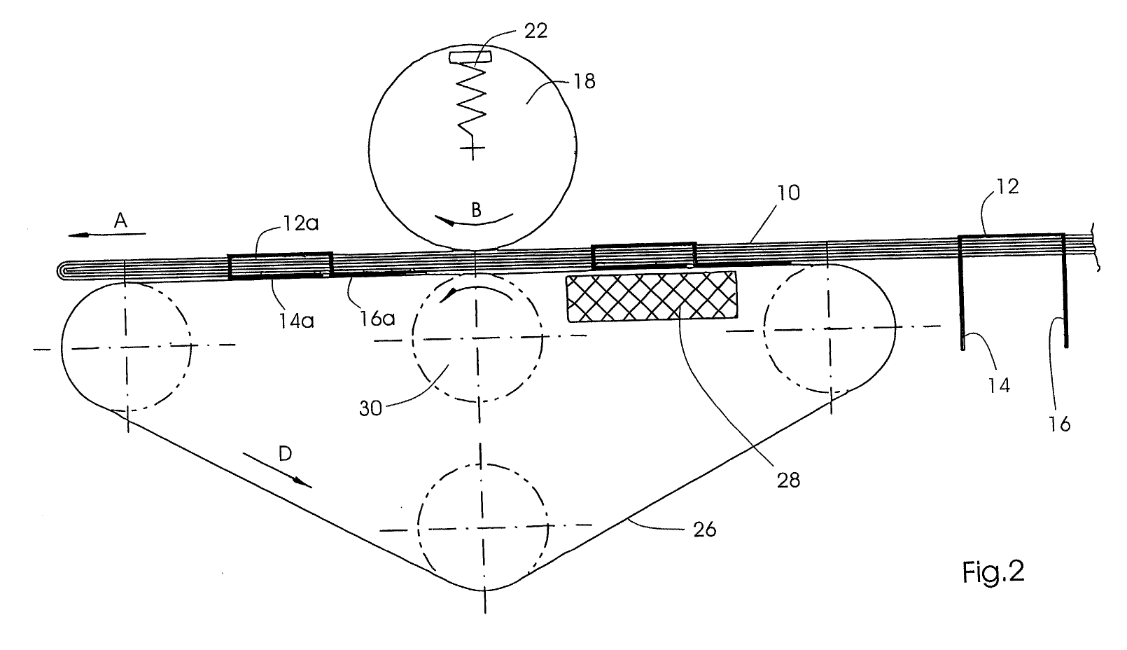

FIG. 2 shows a schematic representation of a further embodiment of the present invention. A folded sheet 10 is moved along conveying direction A. In this context, the motion of the folded sheet in conveying direction A is assisted, first of all, by counter-pressure roller 18 which rotates in direction B. Secondly, the folded sheet rests on the surface of a sealing belt 26 which moves in direction D and, in doing so, has a speed which, at the contact surface with folded sheet 10, is essentially equal to the speed of folded sheet 10. Counter-pressure roller 18 has a counter-pressure element 22 and is arranged in such a manner that a gap arises between sealing belt 26 and counter-pressure roller 18 through which folded sheet 10 with its previously inserted thread clamps 12 is moved. Subsequent to inserting thread clamp 12, the two thread clamp legs 14 and 16 are vertically directed downward, according to FIG. 1. However, as soon as the two thread clamp legs 14 and 16 enter into the gap formed by sealing belt 26 and the surface of folded sheet 10 facing it, the two thread clamp legs are turned down. With the assistance of a heating element 28 located near the surface of sealing belt 26 and facing the folded sheet, each of the two thread clamp legs is heated while the thread clamp runs through so that the thermoplastic component existing in the thread clamp melts allowing the sealing thread to firmly bond to folded sheet 10 shortly thereafter. Subsequent to passing the region of heating element 28, the two thread clamp legs 14a and 16a are firmly joined to folded sheet 10. It is possible for this bond to be additionally improved by at least one pressure roller 30 arranged under the conveying belt opposite of counter-pressure roller 18.

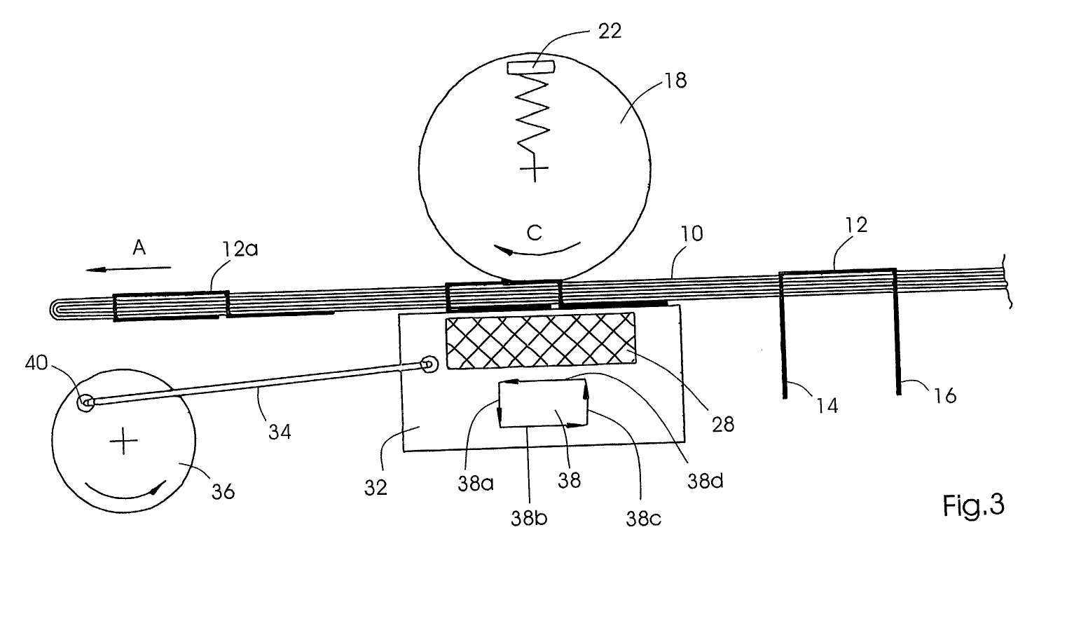

In a further embodiment which is shown in FIG. 3, the sealing element has a slide which is movable in conveying direction A and which contains a heating element 28. Sealing slide 32 is capable of carrying out a motion curve 38 which can be generated, for example, by connecting sealing slide 32, via a rod 34, to a cam point 40 of a rotating element 36, for example, a disk. However, any other device moving the sealing slide along the desired sealing path, such as a linear motor, can be used here as well. During the movement of sealing slide 32, care is taken that in motion curve section 38d, it is moved essentially at the speed which corresponds to the speed of folded sheet 10 in conveying direction A. By given motion curve 38 it is achieved that, in motion curve section 38b, the sealing slide initially moves in a direction opposite to conveying direction A, the sealing slide not being in contact with folded sheet 10. As soon as the sealing slide begins to move in the direction of motion curve section 38c, the distance between the sealing slide and folded sheet 10 decreases. In this context, care must be taken that sealing slide 32 approaches folded sheet 10 in the region of thread clamp 12 in such a manner that the two thread clamp legs 14 and 16 are turned down in a direction opposite to conveying direction A and subsequently fixed in this position, heated and correspondingly bonded to folded sheet 10 with the concurrent movement of sealing slide 32.

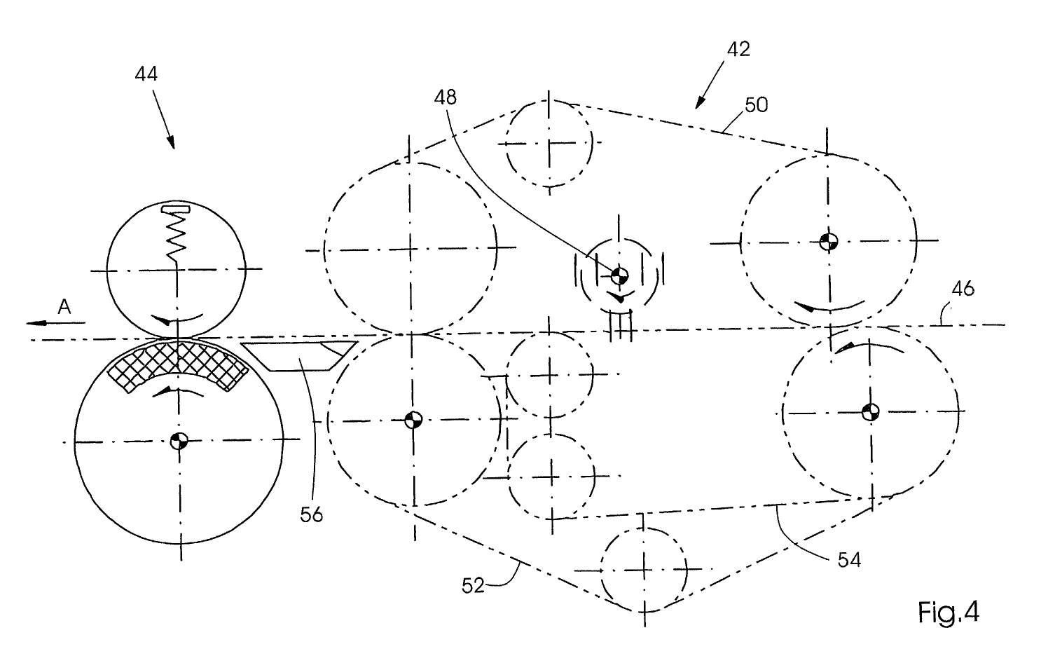

FIG. 4 shows a schematic representation of an embodiment of the device according to the present invention in interaction with an upstream thread station 42 of a thread-sealing machine, each of the previously described devices according to FIGS. 1, 2 and 3 advantageously being usable as sealing station 44. As can be gathered from FIG. 4, thread station 42, which is used for inserting the thread into the material to be sealed, can be completely separated from sealing station 44 if a sealing station 44 is used which has a movable sealing device. In this manner, a markedly more flexible construction can be achieved, resulting in an improved adaptation of the thread-sealing machine to the specific needs.

If thread station 42 is now separated from sealing station 44, it has turned out to be advantageous for a turning-down element 56 to be provided upstream of sealing station 44. In this context, this turning-down element, which is mounted with clearance from conveying path 46, is provided under conveying path 46 in such a manner that the thread clamp legs can be oriented in the desired direction. Since turning-down element 56 does not exert any pressure on the thread clamp legs, the thread clamp legs are turned down in a gentle manner and, consequently, fed to sealing station 44 already in correct orientation. Turning-down element 56 is preferably positioned in such a manner that it bridges the transfer area between thread station 42 and sealing station 44. Accordingly, a folded sheet moves from thread station 42, in which a thread is inserted, via turning-down element 56, in which the thread legs are oriented, into sealing station 44, in which the thread legs are firmly bonded to the material to be sealed.

With the aid of thread station 42, it is possible for the specially twisted thread pieces, which are provided with a meltable component, to be inserted into the folding line of the folded sheet. To this end, usually, a thread insertion gear 48 is used in thread station 42, the thread insertion gear, in cooperation with a thread plate chain 50, a conveying chain 52, and an insertion chain 54 permitting the insertion of the sealing thread into the folded sheet.

The heating elements previously described in FIGS. 1, 2 and 3 can be designed as electrical induction or radiant heaters. Besides, it is possible for the counter-pressure elements to be designed as counter-pressure rollers, belts or slides, the counter-pressure elements, at the point of contact with the folded sheet, moving essentially at the same speed as the folded sheet itself.

What is claimed is:

1. A device for sealing stitching threads on material to be sealed to a moving folded sheet comprising:
a heatable sealing element, having a surface which touches a material to be sealed to a moving folded sheet during the sealing operation at a contact surface, the heatable sealing element being designed in such a manner that, during the sealing operation, the contact surface moves essentially at the same speed as the folded sheet.

2. The device as recited in claim 1, wherein the heatable sealing element is a rotating sealing roller.

3. The device as recited in claim 1, wherein the heatable sealing element is a continuous sealing belt.

4. The device as recited in claim 1, wherein
the heatable sealing element includes
a sealing slide;
a first movement device, the first movement device moving the sealing slide linearly in a conveying direction of the folded sheet; and
a second movement device, the second movement device moving the sealing slide away from the folded sheet.

5. The device as recited in claim 4, wherein the first and second movement devices are comprised of a single device which moves the sealing slide linearly in the conveying direction of the folded sheet and which moves the sealing slide away from the folded sheet.

6. The device as recited in claim 5, wherein the single device comprises a rod connected to a cam point of a rotating element, the rod being connected to the sealing slide.

7. The device as recited in claim 1, wherein the sealing element has a heating element.

8. The device as recited in claim 7, wherein the heating element is one of an induction heater, a revolving heating cartridge and a radiant heat source.

9. The device as recited in claim 1, further comprising a counter-pressure element opposite of the heatable sealing element.

10. The device as recited in claim 9, wherein the counter-pressure element is one of a counter-pressure roller, counter-pressure belt, and counter-pressure slide.

11. The device as recited in claim 9, wherein a surface of the counter-pressure element which touches the folded sheet moves essentially at the same speed as the folded sheet.

12. A method for hot-sealing material to be stitched, in particular made of paper, cardboard or the like, comprising the steps of:
introducing hot-sealable thread clamps into a material to be stitched in the region of a folding line;
moving the material to be stitched along a path in the direction of a hot-sealing element;
bringing the material to be stitched and the hot-sealable thread clamps into contact with a heatable sealing element, the surface of the heatable sealing element which is in contact with the material to be stitched and with the thread clamps moving essentially at the same speed as the material to be stitched.

13. The method as recited in claim 12, wherein the sealing element is a heatable sealing roller of which the material to be stitched rolls off.

14. The method as recited in claim 12, wherein the sealing element is designed as a sealing belt which, in one of its subsections, is in contact with the material to be stitched.

15. The method as recited in claim 12, wherein the sealing element is a movable slide which is moved in such a manner that it is in contact with the material to be stitched in a subsection of the conveying path of the material to be stitched, and in that it is subsequently moved away from the material to be stitched, and which, subsequent to moving away, is moved in a direction opposite to the conveying direction of the material to be stitched.

16. The method as recited in one of the claims 12, wherein a counter-pressure element is provided opposite of the heatable sealing element, the counter-pressure element moving essentially at the same speed as the material to be stitched, and the material to be stitched moves between the counter-pressure element and the sealing element.

17. The method as recited in claims 16, wherein
the counter-pressure element is one of a as counter-pressure roller, counter-pressure belt, or a movable counter-pressure slide.

18. A thread-sealing machine, wherein
the thread-sealing machine has a device according to claim 1.
